(19) United States
(12) Patent Application Publication
(10) Pub. No.: US 2006/0119278 A1
(43) Pub. Date: Jun. 8, 2006

(54) GAS DECOMPOSITION APPARATUS AND GAS TREATMENT CARTRIDGE

(75) Inventors: Yoshiaki Kaneko, Tokyo (JP); Junichi Tamura, Inagi-shi (JP); Kenichiro Iuchi, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/275,014

(22) Filed: Dec. 1, 2005

(30) Foreign Application Priority Data
Dec. 7, 2004 (JP) 2004-354050

(51) Int. Cl. H01J 7/24; H01J 17/26

(52) U.S. Cl. 315/111.21; 313/231.31

(57) ABSTRACT

There is provided a gas decomposition apparatus including: at least a pair of electrodes, each of which are formed of metal electrodes each covered with a dielectric substance, for inducing glow discharge under application of a high voltage; a dielectric substance formed into a shape which allows a gas to be decomposed to flow in the dielectric substance and provided between the pair of electrodes; and a plasma reactor provided therein with the pair of electrodes and the dielectric substance. A gap is formed between at least one electrode of the pair of electrodes and the dielectric substance, and the dielectric substance is arranged in the plasma reactor such that a substantially total volume of the gas to be decomposed flows in the dielectric substance. Such a constitution allows formation of a uniform and high-density electric field and gas treatment at a high decomposition efficiency.

### BACKGROUND OF THE INVENTION

1. Field of the Invention

The present invention relates to a gas decomposition apparatus for detoxifying a gas containing volatile organic compounds (hereinafter, referred to as “VOC”) exhausted from various industrial processes through an atmospheric plasma decomposition method, and to a gas treatment cartridge.

2. Related Background Art

VOC are toxic chemical substances such as toluene, xylene, and methyl ethyl ketone (MEK) generated during a coating process or the like which uses an organic solvent. In actuality, VOC had been emitted into atmosphere. However, reduction of VOC, which are substances applying environmental load, has been demanded socially, reflected by a recent enforcement of Pollutant Release and Transfer Register (PRTR), for example. Thus, a VOC detoxification technique has been studied extensively. The VOC detoxification technique employs a photodecomposition method, a catalyst decomposition method, a power burner combustion method, and the like, but those techniques have problems such as increase in apparatus size, increase in operational cost, generation of toxic substances, and treatment efficiency. An electric discharge-type VOC detoxification technique has attracted attention recently as a technique for overcoming those problems. The electric discharge-type VOC detoxification technique involves: generating electric discharge under atmospheric pressure; and treating VOC by means of the electric discharge. The electric discharge-type technique is classified into a silent discharge method, a creeping discharge method, a pulse corona discharge method, a dielectric filling method, or the like in accordance with an electric discharge method.

The dielectric filling method involves: applying a voltage to a dielectric; inducing glow discharge in a gap between the dielectrics under atmospheric pressure (under normal pressure, for example); and generating plasma. The dielectric filling method further involves: allowing flow of VOC as a gas to be decomposed through the gap in which the plasma is generated; and decomposing VOC into carbon dioxide and water by an oxidative effect of the plasma. Thus, in the dielectric filling method, it is important to form a uniform and high-density electric field on a surface of the dielectric, and several techniques are disclosed therefor.

First, there is disclosed an air cleaner including: a pair of electrodes; porous ceramics coated with a photocatalyst and arranged between the pair of electrodes; and a buffer material arranged between each of the electrodes and the ceramics (see Japanese Patent Application Laid-Open No. 2002-253658). According to this technique, the arrangement of the buffer material allows generation of planer electric discharge along a surface of the ceramics provided in an electrically discharged space, increases a voltage difference between a corona discharge minimum voltage for discharge and spark discharge minimum voltage for discharge, and allows stable electric discharge. Further, there is proposed a technique of preventing spark discharge by covering each electrode with a dielectric (see Japanese Patent Application Laid-Open No. 2004-105811).

However, in the case where the buffer material is arranged as disclosed in Japanese Patent Application Laid-Open No. 2002-253658, moisture adheres to the surface of the ceramics held between the buffer materials during flow of a high humidity gas, and a uniform and high-density electric field is hardly formed on the surface of the ceramics. Further, in the case where each electrode is covered with a dielectric as disclosed in Japanese Patent Application Laid-Open No. 2004-105811, the electrodes and the ceramics held between the electrodes are in contact with each other. Thus, an electric field is formed focusing only in the vicinity of electrode contact points, thereby preventing spark discharge. However, this case has a problem in that treatment efficiency degrades.

Thus, there is disclosed a plasma generator as a technique for solving such a problem, including: a pair of electrodes each covered with a dielectric; a carrier such as zeolite inserted between the pair of electrodes; and a space between the carrier and each of the electrodes allowing flow of a gas to be decomposed (see Japanese Patent Application Laid-Open No. H11-347342).

In a constitution disclosed in Japanese Patent Application Laid-Open No. H11-347342, the gas flows in a direction parallel to the electrodes. Thus, in order to increase a volume of a plasma generation portion, the electrodes each covered with a dielectric and the carrier must be laminated alternately, which results in a complex electrode structure. Further, in order to form a stable and high-density electric field between each of the electrodes and the carrier, a length between each of the electrodes and the carrier must be about several mm, which causes a large pressure loss during flow of the gas to be decomposed through the space between each of the electrodes and the carrier. Even when a porous carrier is used, the gas flows more easily through the space between the each of the electrodes and the carrier than through pores of the porous carrier because the gas flows in a direction parallel to the electrodes. Thus, a volume of the gas flowing through the pores of the carrier reduces, which causes a problem of inhibiting efficient use of the pores of the carrier for gas treatment even when an adsorbent or catalyst-supported zeolite is used as the carrier.

### SUMMARY OF THE INVENTION

The present invention has been made in view of the above-mentioned problems, and an object of the present invention is therefore to provide a gas decomposition apparatus and a gas treatment cartridge allowing formation of a uniform and high-density electric field regardless of a humidity environment of a gas to be decomposed and allowing gas treatment at a high decomposition efficiency with a small pressure loss during flow of the gas to be decomposed.

In order to achieve the object, there is provided a gas decomposition apparatus including: at least a pair of electrodes, each of which are formed of metal electrodes each covered with a dielectric substance, for inducing glow discharge under application of a high voltage; a dielectric substance formed into a shape which allows a gas to be decomposed to flow in the dielectric substance and provided between the pair of electrodes; and a plasma reactor provided therein with the pair of electrodes and the dielectric substance, the treatment of the gas to be decomposed being performed by introducing the gas to be decomposed into the plasma reactor while glow discharge is induced between the pair of electrodes to generate plasma in the plasma reactor under atmospheric pressure, in which: a gap is formed between at least one electrode of the pair of electrodes and the dielectric substance; and the dielectric substance is arranged in the plasma reactor such that the gas to be decomposed flows in a direction perpendicular to the plane of each of the dielectric substances forming the gap.

The present invention can provide a gas decomposition apparatus and a gas treatment cartridge allowing formation of a uniform and high-density electric field regardless of a humidity environment of a gas to be decomposed and allowing gas treatment at a high decomposition efficiency with a small pressure loss during flow of the gas to be decomposed.

Other features and advantages of the present invention will be apparent from the following description taken in conjunction with the accompanying drawings.

### BRIEF DESCRIPTION OF THE DRAWINGS

FIG. 1 is a schematic structural diagram showing an embodiment of a gas decomposition apparatus according to the present invention;

FIG. 2 is a schematic perspective view showing a cartridge including the ground electrodes, high-voltage electrodes, and dielectric substances shown in FIG. 1;

FIG. 3 is a perspective view showing a modified example of the cartridge shown in FIG. 2;

FIG. 4 is a diagram showing a schematic structure of a gas decomposition apparatus used in each of Examples and Comparative Examples of the present invention; and

FIG. 5 is a table showing the main conditions and results of each of Examples and Comparative Examples of the present invention.

### DETAILED DESCRIPTION OF THE PREFERRED EMBODIMENTS

Next, embodiments of the present invention will be described with reference to figures.

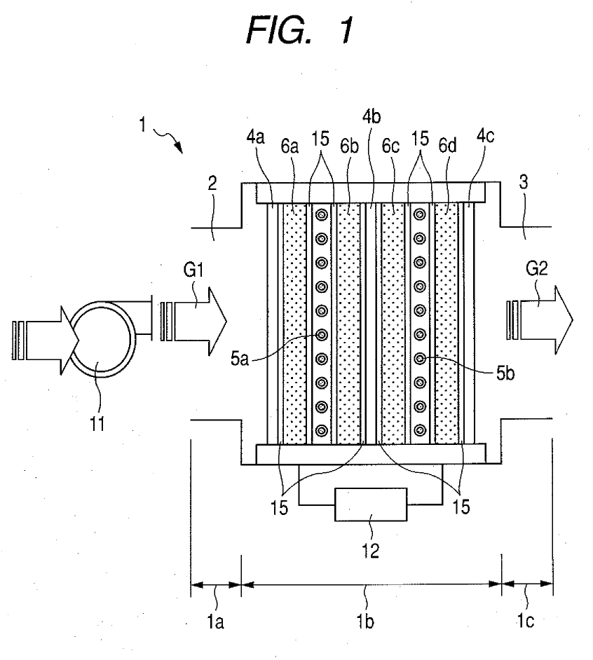

FIG. 1 is a schematic structural diagram showing an embodiment of a gas decomposition apparatus according to the present invention.

A gas decomposition apparatus 1 is provided with: a gas introduction portion 1a including a gas introduction port 2 for introducing a gas to be decomposed G1, which is a material for decomposition; a plasma reactor 1b for subjecting to plasma treatment the gas to be decomposed G1 flowing in from the gas introduction portion 1a; and a gas exhaust portion 1c including a gas exhaust port 3 for exhausting out of a system a treated gas G2 obtained through plasma treatment in the plasma reactor 1b. Further, a fan 11 for feeding the gas to be decomposed G1 into the gas introduction portion 1a is provided upstream of the gas introduction portion 1a with respect to a flow direction of the gas.

The plasma reactor 1b is provided with a ground electrode 4a, a dielectric substance 6a, a high-voltage electrode 5a, a dielectric substance 6b, a ground electrode 4b, a dielectric substance 6c, a high-voltage electrode 5b, a dielectric substance 6d, and a ground electrode 4c in the order given from the upstream with respect to the flow direction of the gas. Further, a gap 15 is formed between each of the ground electrodes 4a, 4b, and 4c, high-voltage electrodes 5a and 5b, and dielectric substances 6a, 6b, 6c, and 6d. FIG. 1 shows all gaps that may exist, but in the present invention, at least one gap needs to exist. A length of the gap may be selected arbitrarily in accordance with an applied voltage or a humidity of a gas to be decomposed. A length of less than 0.5 mm is liable to cause unstable electric discharge at high humidity, and a length of 1.6 mm or more requires a high-applied voltage for plasma generation. Thus, the length of the gap is preferably about 0.5 mm to 1.5 mm. Those members are each arranged across an entire cross section of the plasma reactor 1b such that a total volume of the gas to be decomposed G1 flows through the members. In FIG. 1, the dielectric substances are each arranged in the plasma reactor such that the gas to be decomposed flows in a direction perpendicular to a plane of each of the dielectric substances forming a gap.

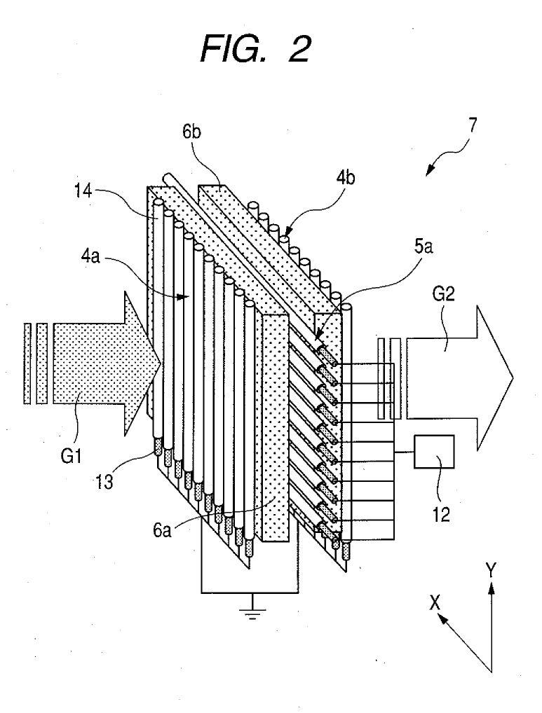

Further, as shown in FIG. 2, the ground electrodes 4a, 4b, 4c, 5a, and 5b are each formed of a plurality of metal electrodes 13 each covered with a dielectric 14. In each of the ground electrodes 4a, 4b, and 4c and high-voltage electrodes 5a and 5b, the plurality of metal electrodes 13 are arranged at intervals. Thus, the ground electrodes and the high-voltage electrodes each define air holes allowing flow of the gas to be decomposed G1 through the metal electrodes 13.

The ground electrodes 4a, 4b, and 4c (hereinafter, sometimes abbreviated as “ground electrodes 4a etc.”) and the high-voltage electrodes 5a and 5b (hereinafter, sometimes abbreviated as “high-voltage electrodes 5a etc.”) are each formed of the plurality of metal electrodes 13 each covered with the dielectric 14. The ground electrodes 4a, 4b, and 4c are each connected to the ground through an arbitrary method, and the high-voltage electrodes 5a and 5b are each connected to an AC high-voltage power supply 12. The ground electrode 4a and the high-voltage electrode 5a, the ground electrode 4b and the high-voltage electrode 5a, the ground electrode 4b and the high-voltage electrode 5b, and the ground electrode 4c and the high-voltage electrode 5b face each other, respectively, thereby forming electrode pairs. A high AC voltage is applied to the high-voltage electrodes 5a and 5b from the high-voltage power supply 12, to thereby induce glow discharge between each of the electrode pairs under atmospheric pressure to generate plasma. Each of the dielectric substances 6a to 6d provided between each of the electrode pairs is exposed to plasma generated therebetween.

Note that the number of the high-voltage electrodes and ground electrodes in the gas decomposition apparatus 1 can be changed arbitrarily in accordance with a material for decomposition or a required decomposition efficiency. The high-voltage power supply 12 may employ a frequency in a range of a commercial frequency of 50 Hz or 60 Hz to a high frequency (MHz), and often employs a voltage within a range of several kV to several tens kV. However, the high-voltage power supply that may be used for the gas decomposition apparatus 1 according to the embodiment of the present invention is not limited thereto. Note that the same reference symbols in the following figures as those of FIG. 1 represent the same members.

FIG. 2 is schematic perspective view showing a cartridge including the ground electrodes, high-voltage electrodes, and dielectric substances shown in FIG. 1.

A cartridge 7 is a package integrally formed of the ground electrodes 4a etc., the high-voltage electrodes 5a etc., and the dielectric substances 6a and 6b (hereinafter, sometimes abbreviated as “dielectric substances 6a etc.”), and can be loaded detachably into the plasma reactor 1b of the gas decomposition apparatus 1 shown in FIG. 1. Thus, the cartridge 7 can be changed arbitrarily after being used for a certain period of time or in accordance with a degree of performance degradation. Further, the gas decomposition apparatus 1 includes a holding portion (not shown) for holding the cartridge 7 to be detachable in the plasma reactor 1b. Nevertheless, such a cartridge system may be employed arbitrarily.

The high-voltage electrodes 5a etc. and the ground electrodes 4a etc. are each formed of the plurality of rod-like metal electrodes 13 each covered with the dielectric 14, for example. The metal electrodes 13 each preferably have an outer diameter of about 1 mm to 2 mm. Examples of a material to be used for the metal electrodes 13 include stainless steel, copper, brass, aluminum, iron, and tungsten. Ceramics having a high dielectric constant is preferably used as the dielectric 14 covering each of the metal electrodes 13, and examples of the ceramics include dielectric substances such as alumina, zirconium oxide, silicon oxide, and barium titanate. The dielectric 14 may have an arbitrarily selected thickness inhibiting dielectric breakdown at an applied voltage, but preferably has a thickness of about 100 μm to 500 μm for suppressing discharge minimum voltage for discharge.

Examples of a method of covering each of the metal electrodes 13 with the dielectric 14 include: a method involving inserting the metal electrodes 13 into tube-like ceramics; and a method involving subjecting the metal electrodes 13 to ceramics coating. The method involving ceramics coating is preferably employed in consideration of possible reduction of power efficiency due to electric discharge in the gap between each of the metal electrodes 13 and the dielectric 14. Each of the metal electrodes 13 covered with the dielectric 14 has an appropriately selected shape, to thereby allow holding of the dielectric substances 6a etc., uniform application of a voltage to the dielectric substances 6a etc., and passing the gas to be decomposed G1 through the dielectric substances 6a etc. without suffering from a large pressure loss.

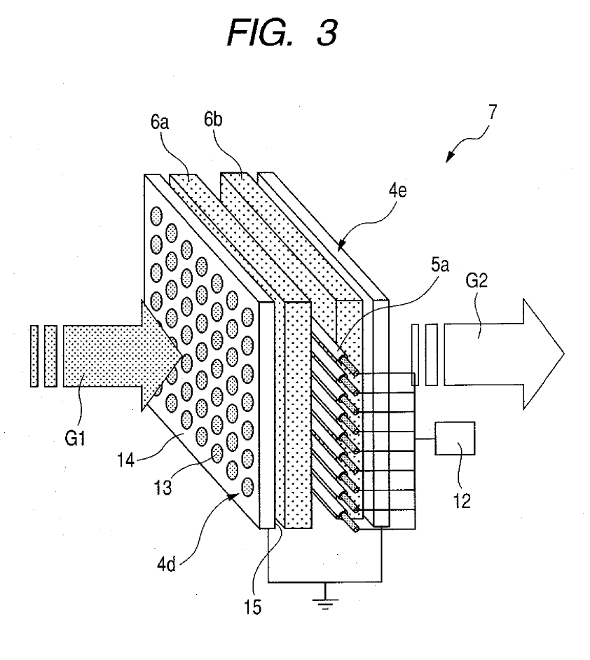

FIG. 3 is a perspective view showing a modified example of the cartridge shown in FIG. 2. As shown in FIG. 3, ground electrodes 4d and 4e each covered with the dielectric 14 formed by subjecting the metal electrode 13 of a shape (such as a lattice-like shape, a porous shape, or a punching board) with air holes allowing gas flow to surface ceramics coating may be used instead of the ground electrodes 4a and 4b each formed of the rod-like metal electrodes 13 each covered with the dielectric 14 as the cartridge shown in FIG. 2.

Next, a structure of each of the dielectric substances 6a etc. will be described. A basic structure of each of the dielectric substances 6a etc. is a porous dielectric substrate. To be specific, the dielectric substrate is formed of honeycomb ceramics, ceramics particulate sintered member, or the like. In particular, each of the dielectric substances 6a etc. preferably includes a dielectric substrate formed of ceramics as a skeleton portion, and flow channels formed three dimensionally and in a network thereinside for high strength and small pressure loss.

The dielectric substrate is preferably covered with a ferroelectric film having a higher dielectric constant than that of the dielectric substrate, to thereby allow plasma generation at a low applied voltage and suppress heat generation of the dielectric. Aluminum, zirconium oxide, or the like having a dielectric constant of 50 or less is desirably used as a material for the dielectric substrate. Barium titanate, strontium titanate, or the like having a dielectric constant of 1,000 or more is desirably used as a material for the ferroelectric film. For further improvement of treatment efficiency, a surface of the ferroelectric film is preferably covered with an adsorbent capable of adsorbing or holding a substance to be treated or with a catalyst capable of accelerating a treatment reaction. Examples of a material used therefor include: adsorbents such as zeolite and γ-alumina; and precious metals such as platinum, palladium, rhodium, nickel, manganese dioxide, and silver.

Next, an operation of the gas decomposition apparatus 1 according to the embodiment of the present invention will be described. Referring to FIG. 1, the gas to be decomposed G1 containing VOC flows successively into the dielectric substances 6a etc. in the plasma reactor 1b from the gas introduction portion 1a by means of the fan 11. A voltage is applied between each of the ground electrodes 4a etc. and high-voltage electrodes 5a etc. by means of the high-voltage power supply 12. Electric discharge generates on the surface and inside pores of each of the dielectric substances 6a etc. held between each of the ground electrodes 4a etc. and high-voltage electrodes 5a etc., to thereby generate plasma under atmospheric pressure (normal pressure, for example). The gas to be decomposed G1 allowed to flow into the pores of the dielectric substances 6a etc. is oxidized and decomposed by the plasma while being in contact with the plasma, and then is detoxified. The detoxified treated gas G2 transfers to the gas exhaust portion 1c and is exhausted out of the gas decomposition apparatus 1 through the gas exhaust port 3.

As described above, in the gas decomposition apparatus according to the embodiment of the present invention, the gap 15 is provided at least between each of the ground electrodes 4a etc., high-voltage electrodes 5a etc., and dielectric substances 6a etc. Further, the high-voltage electrodes 5a etc. and the ground electrodes 4a etc. are each formed of the metal electrodes 13 each covered with the dielectric 14. Thus, the gas decomposition apparatus allows: formation of a uniform and high-density electric field on a surface of each of the dielectric substances 6a etc. regardless of a humidity environment of the gas to be decomposed during the above-mentioned gas treatment operation while suppressing generation of spark discharge and without generating discharge focused in the vicinity of the electrodes: and gas treatment at high efficiency.

Further, the gas decomposition apparatus according to the embodiment of the present invention has a structure allowing flow of the gas to be decomposed G1 in a direction perpendicular to a plane (plane parallel to an XY plane shown in FIG. 2) of each of the dielectric substances 6a etc. of the cartridge 7. Thus, a substantially total volume of the gas to be decomposed G1 flows through the entire plane of each of the dielectric substances 6a etc. That is, the cartridge is arranged in the plasma reactor such that the gas to be decomposed flows in a direction perpendicular to the plane of each of the dielectric substances forming the gap, to thereby reduce pressure loss caused during flow of the gas to be decomposed G1 through the cartridge 7 compared with that of prior art in which the gas to be decomposed flows through a narrow space between each of the electrodes and the carrier.

Further, in the structure according to the embodiment of the present invention, a substantially total volume of the gas to be decomposed G1 allowed to flow in the plasma reactor 1b flows through the dielectric substances 6a etc. Thus, a space inside pores of the dielectric substances 6a etc. may be used efficiently for gas treatment. The space inside pores of the dielectric substances 6a etc. has a large surface area, to thereby increase a chance of contact between the gas to be decomposed G1 flowing through the space inside pores and the plasma generated in the space inside pores. Thus, treatment efficiency of the gas to be decomposed G1 can be improved compared with that of prior art in which the gas to be decomposed flows through a narrow space between each of the electrodes and the carrier and gas treatment is performed substantially on the surface of the carrier. In particular, in the case where the dielectric substances 6a etc. each covered with an adsorbent or catalyst are used, a chance of contact between the gas to be decomposed G1 and the adsorbent or catalyst in the pores increases. Thus, functions of the adsorbent or catalyst may be used more efficiently, to thereby further improve the treatment efficiency.

Effects of gas treatment according to the present invention will be described in more detail by using the following examples. Note that the following examples are mere examples, and the gist of the present invention is not limited thereto.

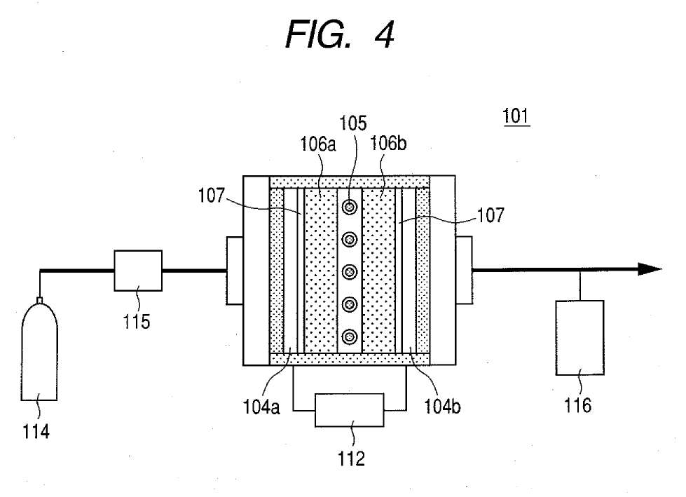

FIG. 4 is a diagram showing a schematic structure of a gas decomposition apparatus used in each of Examples 1 and 2 and Comparative Examples 1 and 2. In each of Examples 1 and 2 and Comparative Examples 1 and 2, a cylinder 114 of a gas to be decomposed filled with the gas to be decomposed was connected to a gas introduction port of a gas decomposition apparatus 101 through a flow controller 115. A plasma reactor of the gas treatment chamber 101 had a chamber volume of 121 cm³. A gas exhaust port of the gas decomposition apparatus 101 was connected to an analytical instrument 116 (gas detector tube, manufactured by Gastec Corporation) through a pipe. The gas to be decomposed was an ammonia gas of 5 ppm with a relative humidity of 80%, and a flow rate thereof was adjusted to 1,000 l/min by using the flow controller 115.

A structure of the respective electrodes and dielectric substances of Example 1 was somewhat simplified compared with those described in the above-mentioned embodiment, and included: a high-voltage electrode 105 connected to a high-voltage power supply 112; ground electrodes 104a and 104b on both sides of the high-voltage electrode 105; and dielectric substances 106a and 106b (outer size of 110 mm×110 mm×5 mm) held between the ground electrode 104a and the high-voltage electrode 105 and between the ground electrode 104b and the high-voltage electrode 105, respectively. The ground electrodes 104a and 104b each had a structure in which a stainless steel rod (1 mmΦ) was inserted into an alumina tube (outer diameter of 2 mmΦ, inner diameter of 1 mmΦ). The high-voltage electrode 105 had a structure in which a tungsten rod (1 mmΦ) was inserted into an alumina tube (outer diameter of 2 mmΦ, inner diameter of 1 mmΦ). A gap 107 of 0.5 mm was provided between the dielectric substance 106a and the ground electrode 104a and between the dielectric substance 106b and the ground electrode 104b, respectively. The dielectric substances 106a and 106b were each produced by: applying barium titanate (dielectric constant of ∈r=4,000) as a ferroelectric film on a porous alumina substrate; calcining the whole at 1,250° C.; and applying high silica zeolite thereon as an adsorbent. The ferroelectric film had a thickness of 20 μm and had an adsorbent application amount of 35 wt %. An average flow channel gap of the dielectric substances 106a and 106b was 1 mm, and the dielectric substances 106a and 106b each had a porosity of 80%.

In Example 2, a gap of 0.5 mm was provided between the dielectric substance 106a and the ground electrode 104a and between the dielectric substance 106b and the ground electrode 104b. Other conditions were the same as those of Example 1.

In Comparative Example 1, a stainless steel rod (1 mmΦ) covered with no alumina tube was used for each of the ground electrodes 104a and 104b. In Comparative Example 2, the high-voltage electrode 105, the ground electrodes 104a and 104b, and the dielectric substances 106a and 106b were in contact with each other, and no gaps were provided therebetween. Other conditions of Comparative Example 1 and 2 were the same as those of Example 1.

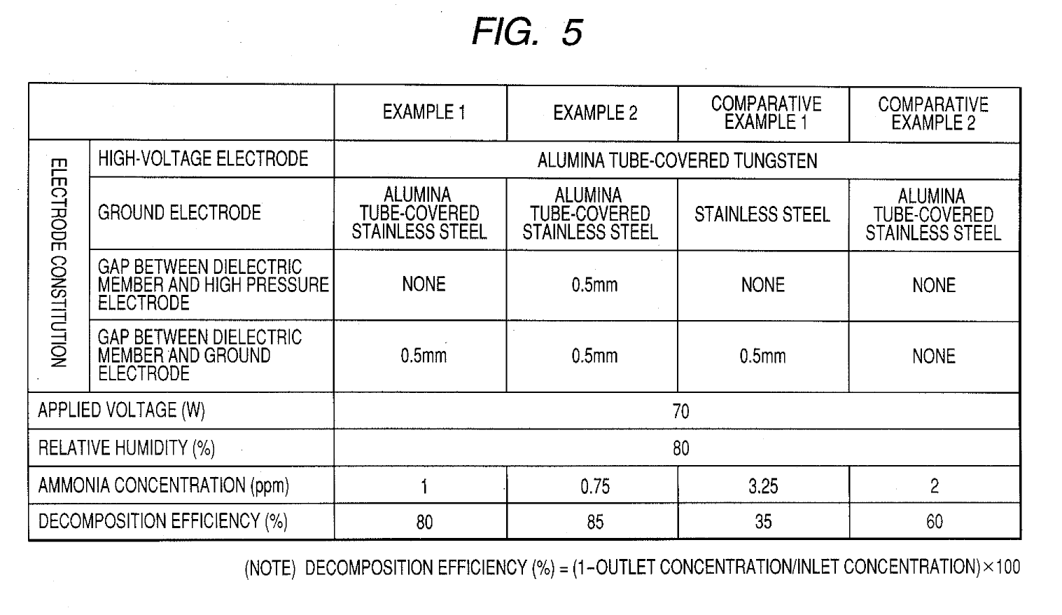

Detoxification treatment of the gas to be decomposed was conducted by using the gas decomposition apparatus 101 for each of Examples 1 and 2 and Comparative Examples 1 and 2. FIG. 5 shows the main conditions and results of each of the examples. The decomposition efficiency was defined as shown in FIG. 5.

In Comparative Example 1, a stainless steel rod covered with no alumina tube was used for each of the ground electrodes 104a and 104b. Thus, a uniform and high-density electric field could not be formed stably at high humidity, and the gas decomposition apparatus degraded treatment performance (decomposition efficiency) compared with those of Examples 1 and 2. In Comparative Example 2, the high-voltage electrode 105, the ground electrodes 104a and 104b, and the dielectric substances 106a and 106b were in contact with each other, and no gaps were provided therebetween. Thus, an electric field was focused in the vicinity of the electrodes at high humidity, and the gas decomposition apparatus degraded treatment performance (decomposition efficiency) compared with those of Examples 1 and 2.

As described above in the present invention, the gap is formed between at least one electrode of the pair of electrodes formed of the metal electrodes each covered with the dielectric substance and the dielectric substance, to thereby allow formation of a uniform and high-density electric field regardless of gas humidity and improve treatment efficiency of the substance to be treated. Further, the dielectric substance is arranged in the plasma reactor for allowing flow of a substantially total volume of the gas to be decomposed through the dielectric substance in a direction perpendicular to a plane of the dielectric substance forming the gap, to thereby reduce pressure loss during flow of the treated gas. Further, a substantially total volume of the gas to be decomposed G1 allowed to flow through the plasma reactor 1b flows through the dielectric substances 6a etc., to thereby allow efficient use of space inside pores of the porous dielectric substances 6a etc. for gas treatment.

The gas decomposition apparatus and gas treatment cartridge of the present invention allow treatment of VOC or odor materials, and thus can be widely used for treatment of odor materials discharged from contaminated soil and for gas treatment in an indoor accommodation space where people gather, a living room of a house or the like, a space inside an automobile, and a space requiring deodorization.

This application claims priority from Japanese Patent Application No. 2004-354050 filed Dec. 7, 2004, which is hereby incorporated by reference herein.

What is claimed is:

1. A gas decomposition apparatus comprising:
at least a pair of electrodes, each of which are formed of metal electrodes each covered with a dielectric substance, for inducing glow discharge under application of a high voltage;
a dielectric substance formed into a shape which allows a gas to be decomposed to flow in the dielectric substance and provided between the pair of electrodes; and
a plasma reactor provided therein with the pair of electrodes and the dielectric substance,
the treatment of the gas to be decomposed being performed by introducing the gas to be decomposed into the plasma reactor while glow discharge is induced between the pair of electrodes to generate plasma in the plasma reactor under atmospheric pressure, wherein:
a gap is formed between at least one electrode of the pair of electrodes and the dielectric substance; and
the dielectric substance is arranged in the plasma reactor such that a substantially total volume of the gas to be decomposed flows in the dielectric substance.

2. The gas decomposition apparatus according to claim 1, wherein the dielectric substance is arranged in the plasma reactor such that the gas to be decomposed flows in a direction perpendicular to a plane of the dielectric substance forming the gap.

3. The gas decomposition apparatus according to claim 1, wherein the dielectric substance is formed into a porous shape.

4. The gas decomposition apparatus according to claim 1, wherein:
the pair of electrodes and the dielectric substance are formed into an integrated cartridge; and
the plasma reactor is provided with a holding portion for detachably holding the cartridge therein.

5. A gas treatment cartridge integrally comprising:
at least a pair of electrodes, each of which are formed of metal electrodes each covered with a dielectric substance, for inducing glow discharge under application of a high voltage; and
a dielectric substance formed into a shape which allows a gas to be decomposed to flow in the dielectric substance and provided between the pair of electrodes, wherein
a gap is formed between at least one electrode of the pair of electrodes and the dielectric substance.

6. The gas treatment cartridge according to claim 5, wherein the dielectric substance is formed into a porous shape.

7. The gas treatment cartridge according to claim 5:
which is detachably arranged in a plasma reactor of a gas decomposition apparatus for treating a gas to be decomposed by introducing the gas to be decomposed into the plasma reactor while glow discharge is induced between the pair of electrodes to generate plasma under atmospheric pressure; and
which is arranged in the plasma reactor such that a substantially total volume of the gas to be decomposed flows in the dielectric substance.

8. The gas treatment cartridge according to claim 7, which is arranged in the plasma reactor such that the gas to be decomposed flows in a direction perpendicular to a plane of the dielectric substance forming the gap.
